(19) United States
(12) Patent Application Publication
(10) Pub. No.: US 2011/0007893 A1
(43) Pub. Date: Jan. 13, 2011

(54) METHOD AND APPARATUS FOR FINGERPRINTING AND COPY PROTECTING OPTICAL RECORDING MEDIA

(76) Inventors: Berk Sunar, Boylston, MA (US); Ghaith Hammouri, Worcester, MA (US); Aykutlu Dana, Bilkent (TR)

Correspondence Address: BURNS & LEVINSON, LLP, 125 SUMMER STREET, BOSTON, MA, 02110, US

(21) Appl. No.: 12/831,518

(22) Filed: Jul. 7, 2010

Related U.S. Application Data
(60) Provisional application No. 61/223,898, filed on Jul. 8, 2009.

(51) Int. Cl. G06F 21/24; H04L 9/28

(52) U.S. Cl. 380/28; 726/27; 726/26

(57) ABSTRACT

A method for generating a unique identity for objects having measurable properties. The teachings include deriving unique features of the object and using them to generate a fingerprint for the device. The teachings also include techniques for providing appropriate signal processing for the incoming information from any physical device to be fingerprinted. The invention also includes methods for access control to optical recording media and physical devices.

### CROSS REFERENCE TO RELATED APPLICATIONS

This application claims priority under 35 U.S.C. §119 from U.S. Provisional Patent Application Ser. No. 61/223,898, entitled SYSTEM AND METHOD FOR FINGERPRINTING AND COPY PROTECTING OPTICAL DISCS, filed on Jul. 8, 2009, which is incorporated in its entirety herein by reference.

### BACKGROUND

The invention pertains to method and apparatus for extracting fingerprints from objects, such as, but not limited to, optical discs, that have measurable features.

There is a great need for connecting physical everyday objects and devices to the digital communication infrastructure. By using the distinguishing physical features of devices, everyday objects can be identified in a flexible manner. For instance, no identifiers need be maintained or imprinted to the device during manufacturing. Furthermore physical identification plays a critical role in enabling a plethora of applications. A particularly noteworthy need area is strong authentication of goods against counterfeiting.

Another secure fingerprinting technology, RF-DNA technology can provide unique and unclonable physical fingerprints based on the subtleties of the interaction of devices when subjected to an electromagnetic wave. The fingerprints are used to produce a cryptographic certificate of authenticity (COA) which when associated with a high value good may be used to verify the authenticity of the good and to distinguish it from counterfeit goods.

Another application of manufacturing variability is fingerprinting paper objects. Laser Surface Authentication uses a high resolution laser microscope to capture the image texture from which the fingerprint is developed. A conventional scanner can be used to identify paper documents.

What is needed is a technique to fingerprint optical discs such as compact discs (CDs), digital video discs and Blue-ray discs.

FIG. 6 illustrates the land and pit structures on a typical compact disc (CD). On a typical CD, data are stored as a series of lands and pits arranged in a spiral track on the surface of the CD. The encoding length determines the stored data can assume only a finite list of values. For instance on a CD the encoding length may assume one of nine ideal lengths with minimum value in the range 833, 1111, 1388, 1666, 1944, 2221, 2499, 2777, 3054 nanometers which can also depend on the writing process.

CDs are written in two ways, pressing and burning. In pressed CDs a master template is formed with lands and pits corresponding to the data. The master template is then pressed into blank CDs in order to form a large number of copies. In burned CDs, the writing laser heats the dye layer on the CD-R to a point where it turns dark, thus reflecting the reading laser in a manner consistent with physical lands.

The data content is transformed into what is usually referred to as a channel bit sequence and etched on to the master disc via a low powered laser. When transferred to the disc due to noise the channel bit sequence accumulates variation which is called digital sum variance (DSV). There is a limitation on the DSV accumulation for accurate reproduction of the data content.

To read the data on the CD, the reader shines a laser on the surface of the CD and collects the reflected beam using a photodiode detector which converts the incoming beam to an electrical signal. The signal is then further processed by the reader to deduce the location and length of the lands and pits which results in reading the data on the CD.

What is needed is a technique that can be verified by analyzing data collected from a large number of identical CDs and a number of readers, and that shows how to extract a unique fingerprint for each CD. What is further needed is a technique that takes advantage of manufacturing variability found in the length of the CD lands and pits. Although the variability measured is in the order of nanometers, what is needed is a technique that does not require the use of microscopes or any advanced equipment. Instead, what is needed is an electrical signal that is produced by the photodiode detector inside the CD reader and that is sufficient to measure the desired variability. What is still further needed is a technique that can be used for a number of applications including fingerprinting, copy protecting, access control.

### SUMMARY

The needs set forth above as well as further and other needs and advantages are addressed by the present teachings. The solutions and advantages of the present teachings are achieved by the illustrative embodiment described herein below. While representative embodiments are presented hereinbelow, other embodiments involving objects measurable features are also within the scope of these teachings.

One embodiment of the present teachings can provide a unique identifier for the CD material, and can be extended to any other object which utilizes a similar material, for example, a disc-like material and have geometric features embodied therein. The term “optical tag” is used herein to refer to physical tags which contain an area with a surface similar to that used in CDs. With this property, the authenticity of the optical tags can be used to infer the authenticity of the attached physical object. Similarly, optical tags can be used as access control cards.

In the present embodiment, no changes are required to the mastering system. Instead, subtle variations in the pit/land geometries generated in the existing optical discs production process can be used to extract fingerprints, but particular symbol sequences are not necessary. Furthermore, existing signals in current commercial CD readers can be used to accomplish the present embodiment.

A CD is a physical entity with variation in its geometric properties. The CD is measured to obtain the geometric information of the stored data. The information can undergo one or more of signal processing steps which will generate the extracted features. The extracted features may include information about the geometry of the physical device. Similar physical objects will most likely differ in the extracted features. The extracted features can then be used to generate a fingerprint for the physical source. With similar devices having different fingerprints each device can be uniquely identified.

In the present embodiment, a physical fingerprint generation and reproduction technique are presented. Typically the fingerprint is generated during enrollment of the CD. The fingerprint reproduction step can be applied to recover the fingerprint at a later time for various purposes such as verifying the authenticity or identity of the CD. Furthermore, the fingerprint can be used to provide copy protection for the CD.

For a better understanding of the present teachings, together with other and further teachings thereof, reference is made to the accompanying drawings and detailed description.

### DESCRIPTION OF THE DRAWINGS

FIG. 1 is a schematic block diagram of an illustrative environment of the fingerprint generation method of the present teachings;

FIG. 2 is a block diagram of the fingerprint reproduction method;

FIG. 3 is a block diagram of the signal processing method;

FIG. 4 is a block diagram of the threshold generation method;

FIG. 5 is a block diagram of the threshold reproduction method;

FIG. 5A is a flowchart of the method of the present embodiment for generating a fingerprint;

FIG. 6 is a schematic diagram of pits and lands on an optical disc;

FIG. 7 is a histogram of the dimension of a single location from two identical optical discs in nanometer;

FIG. 8 is a histogram of the normalized dimension of 500 locations from 100 identical optical discs in nanometer;

FIG. 9 is a graphical representation of a fingerprint extracted from an optical media. The graph contains three traces with a horizontal offset artificially introduced on two of the three traces in order to show the similarities in the three traces. The lower two traces are obtained from one reader at two different times. The top trace is obtained using a different reader three months after the first two traces were obtained;

FIG. 10 is a graph of a fingerprint extracted from an optical media identical to the optical media used in FIG. 9. The graph contains three traces with a horizontal offset artificially introduced on two of the three traces in order to show the similarities in the three traces. The lower two traces are obtained from one reader at two different times. The top trace is obtained using a different reader three months after the first two traces were obtained;

FIG. 11 is a block diagram representation of an embodiment of the system of these teachings.

### DETAILED DESCRIPTION

The present teachings are now described more fully hereinafter with reference to the accompanying drawings, in which an illustrative embodiment of the present teachings is shown. The following embodiment and configuration description is presented for illustrative purposes only. Any computer configuration and architecture satisfying the speed and interface requirements herein described may be suitable for implementing the system and method of the present teachings.

“Measurable features,” as used herein, refers to a feature of an object that can be detected and to which a measure can be applied. In the exemplary embodiment of CDs, an examples being the length of a pit. In multilevel CD recording schemes, an example would be the volume of the pit.

“CD,” as used herein, refers to any optical recording medium having geometric features that are detected in order to retrieve the recorded information, whether the information is recorded by embossing, change in reflectivity or other optical property or any other method. As defined herein, CD includes phase change discs, magneto optic discs, optical tape and other optical recording formats and methods.

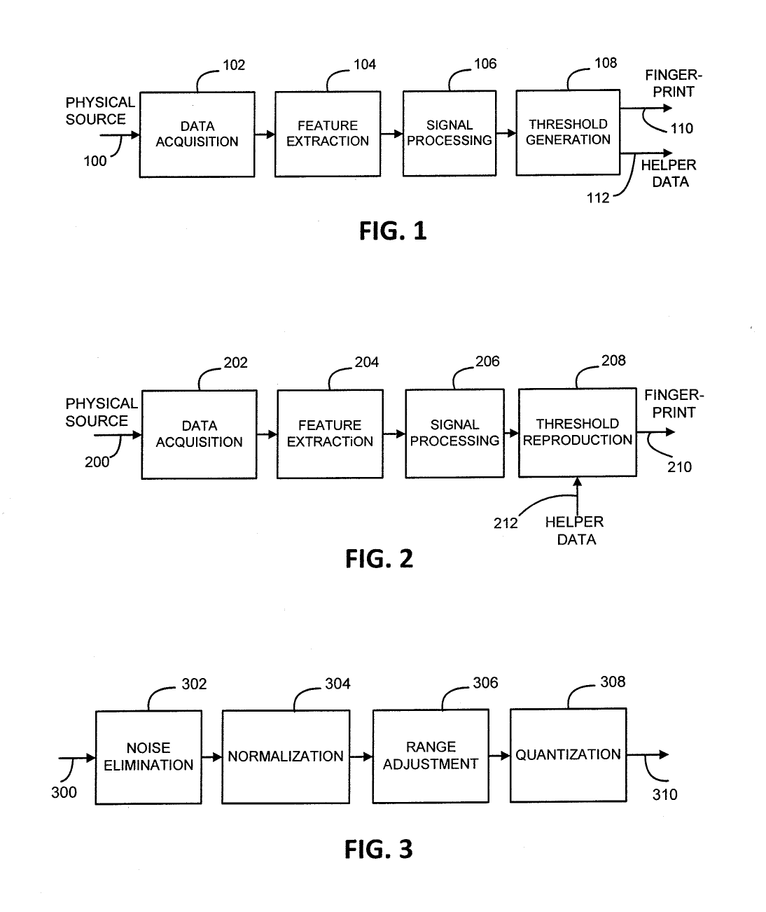

Referring now to FIG. 1, the fingerprint generation process of the present embodiment can include, but is not limited to including, data acquisition process 102 configured to acquire data from physical source 100, extract features process 104 configured to extract significant part of the acquired data, signal processing 106 described hereinbelow, and threshold generation 108 configured to produce fingerprint 110 based on physical source 100 and, optionally, helper data 112. Helper data 112 can provide information to aid in the reproduction of the fingerprint.

Data acquisition process 102 (FIG. 1) may be realized by utilizing a commercially available CD reader that scans the surface of the CD using a laser and records the reflected beam intensity using a detector such as, but not limited to, a detector such as, but not limited to, a photodiode and produces an electrical signal. The same track on the CD can be scanned multiple times to be used for noise elimination.

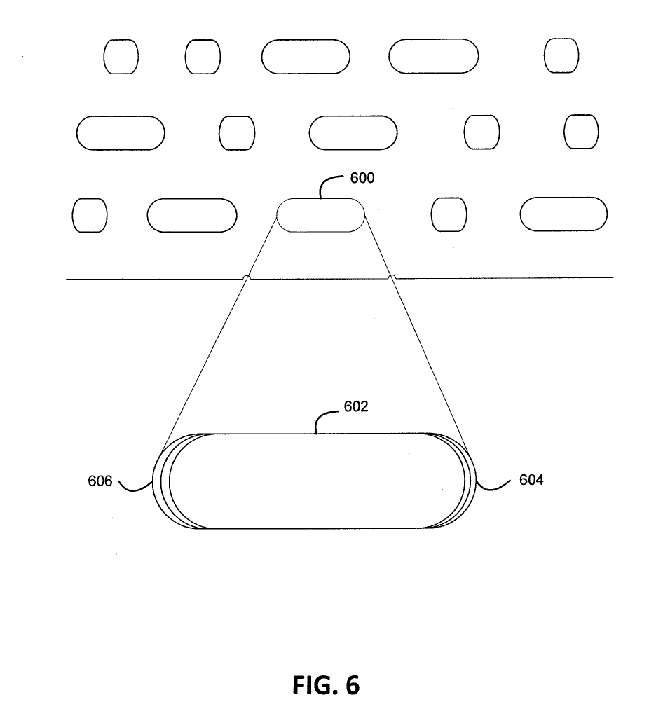

Extract features process 104 (FIG. 1) (also referred to herein as feature extraction process 104) can include, but is not limited to including, the step of extracting the lengths of n pits 600 (or lands) (FIG. 6) from the a electrical signals collected from the same portion of the CD track. The step of extracting can include, but is not limited to including, the step of finding the zero crossings of the signal, and denoting the zero crossings as beginning and ending point of the pits (or lands). Feature extraction process 104 (FIG. 1) can also include the step of obtaining an ordered list of measurements Z¹, Z², . . . , Z^{a-1} where Zⁱ={Zⁱ₀, Zⁱ₁, Zⁱ₂, . . . , Zⁱₙ₋₁} denotes the extracted pit lengths of the selected n features from the i-th measurement. Feature extraction process 104/204 (FIGS. 1 and 2) can remove the undesired parts of the measurements from the acquired data, and can distill the numerical values of n selected physical features. From the repeated measurements is obtained another ordered list of measurements Z¹, Z², . . . , Z^{a-1} which can be denoted using an ordered list of numeric values, e.g. Zⁱ={Zⁱ₀, Zⁱ₁, Zⁱ₂, . . . , Zⁱₙ₋₁}.

Referring now to FIG. 2, the fingerprint reproduction process of the present embodiment can include, but is not limited to including, data acquisition process 202 configured to acquire data from physical source 200, extract features process 204 configured to extract the significant parts of the acquired data, signal processing 206 such as, but not limited to, the methods described hereinbelow, and threshold reproduction 208 configured to reproduce fingerprint 210 based on physical source 200, and optionally, helper data 212.

Referring to FIGS. 1 and 2, data acquisition process 102/202 (FIGS. 1 and 2) can be realized in various ways depending on the nature of the physical source and the availability of acquisition equipment. In one embodiment a laser scanning apparatus, for example, the laser scanning apparatus can be incorporated in commercial compact disc readers which can house a detector such as, but not limited to, a photodiode sensor along with the a low powered laser and mechanical servo system to support a reliable scan operation. This configuration can generate a numeric representation of the physical features which can mimic the scanned surface features. Also printed paper documents can be scanned using commercially available low cost laser scanners. Standard electromagnetic and acoustic imaging techniques which produce a numeric representation of physical objects are also examples of data acquisition methods.

Referring again to FIGS. 1 and 2, data acquisition process 102/202 (FIGS. 1 and 2) can generate a number of repeated measurements from physical source 100, P¹, P², . . . , P^{a-1} where a denotes the number of repeated measurements. Superscripts are used herein to denote distinct measurements from the same physical source. Each measurement can include an ordered list of numeric values. For example, if physical source 100 is a metal object with engravings on its surface, then one way to acquire data from physical source 100 is to scan its surface using a laser source and generate a raster pattern of roughly equally spaced numeric values which represent and image of the surface.

Referring now to FIG. 3, signal processing 106/206 can include, but is not limited to including, noise elimination process 302 configured to reduce the noise in supplied raw data 300, supplied by feature extraction 104/204. Noise elimination process 302 can use a conventional noise reduction technique such as averaging raw data acquired and extracting multiple readings of physical source 100, and optionally processing using curve smoothing algorithms. Signal processing system 106/206 can further include normalization process 304 configured to remove an ideal feature size obtained for a physical feature from the reading and produce normalized measurements. Signal processing system 106/206 can still further include range adjustment process 306 configured to prepare the normalized measurements for quantization by shifting the normalized measurements into a fixed binary range. Signal processing system 106/206 can even still further include quantization process 308 configured to convert real valued data to fit into the fixed binary range and provide those converted data as quantized data 310.

Referring now to FIGS. 3 and 6, signal processing 106 (FIG. 1) can include, but is not limited to including, the steps of reducing noise by computing the average lengths for each pit (or land) length from the a readings, and obtaining a single list Z=z₀, z₁, z₂, . . . , zₙ₋₁ of the average lengths obtained from the n pits (or lands). Normalization process 304 can include, but is not limited to including, the step of subtracting the ideal lengths for the n pits (or lands) lengths. The ideal lengths m₀, m₁, m₂, . . . , mₙ₋₁ for the n locations are determined to the encoded data from among the possible ideal pit (or land) lengths, e.g. for a compact disc
mᵢ ε {833, 1111, 1388, 1666, 1944, 2221, 2499, 2777, 3054}
   nanometers. Normalization process 304 can further include the step of subtracting the ideal lengths, i.e. follows uᵢ=zᵢ−mᵢ for i=0, 1, 2, . . . , n−1, and obtaining a new ordered list u. If the pit or land length could be perfectly manufactured all elements of the list u would be identical to zero. However, edges 606 (FIG. 6) and 604 (FIG. 6) of pits (and lands) vary slightly from one CD to the next. Note that pit 600 (FIG. 6) is blown up to display more detail in 602 (FIG. 6). Moreover, due to vibration noise the same pit or land feature rarely yields the same length when read multiple times.

Referring again to FIG. 3, range adjustment process 306 (FIG. 3) for shifting the measurements to a fixed range can include, but is not limited to including, the steps of obtaining the minimum value w=min(u), and shifting the measurements by the minimum value, i.e. vᵢ=uᵢ−w for i=0, 1, 2, . . . , n−1. Quantization process 308 (FIG. 3) can represent and return elements 310 of the list as integer values of fixed l bits of precision. A list of 500, l=5 bit integer values can be obtained.

Referring to FIGS. 1, 2, and 3, signal processing 106/206 (FIGS. 1 and 2) can further process the extracted features. Noise elimination process 302 (FIG. 3) can average extracted features 300 (FIG. 3) over the multiple measurements, for example,

$${z}_{j} = \frac{1}{n} ( {z}_{j}^{0} + {z}_{j}^{1} + {z}_{j}^{2} + … + {z}_{j}^{a - 1} )$$

for j=0, 1, 2, . . . n−1. Other averaging methods are also within the scope of these teachings. The resulting ordered list is denoted as Z=z₀, z₁, z₂, . . . , zₙ₋₁. Normalization process 304 (FIG. 3) can remove the ideal values denoted by m₀, m₁, m₂, . . . , mₙ₋₁ from extracted features 300 (FIG. 3) as follows: uᵢ=zᵢ−mᵢ for i=0, 1, 2, . . . , n−1. If the ideal feature sizes are not known m₀, m₁, m₂, . . . , mₙ₋₁ may be computed by running data acquisition process 102/202 (FIGS. 1 and 2), feature extraction process 104/204 (FIGS. 1 and 2), and noise elimination process 302 (FIG. 3) with a predetermined number of repeated measurements. The predetermined number is selected so that the noise is reduced to a level where the extraction technique can be applied. In one instance, not a limitation of these teachings, the noise rate has to be below 25% for the extraction technique to work. In many instances, not a limitation of these teachings, if the noise level can be reduced to be below 10% noise extraction techniques can work efficiently. In one instance, where simple averaging techniques are used, about 225 traces were sufficient to obtain a noise rate of about 8%. Different noise reduction technique might be employed to achieve a better noise rate with fewer traces.

Range adjustment process 306 (FIG. 3) can shift the measurements to a fixed range. First the minimum value w=min(U) is found and the measurements are shifted by this value, i.e. vᵢ=uᵢ−w for i=0, 1, 2, . . . , n−1. After the adjustment the list now fits into l=ceil (log₂ (max(v))) where the max(v) function determines the largest elements in their input list, the ceil(v) function returns the closest integer larger or equal to its input, and the log₂□(□) function that returns the logarithm of its input with respect to base 2. Quantization process 308 (FIG. 3) can represent and return the elements 310 (FIG. 3) of the list as integer values of fixed l bits of precision.

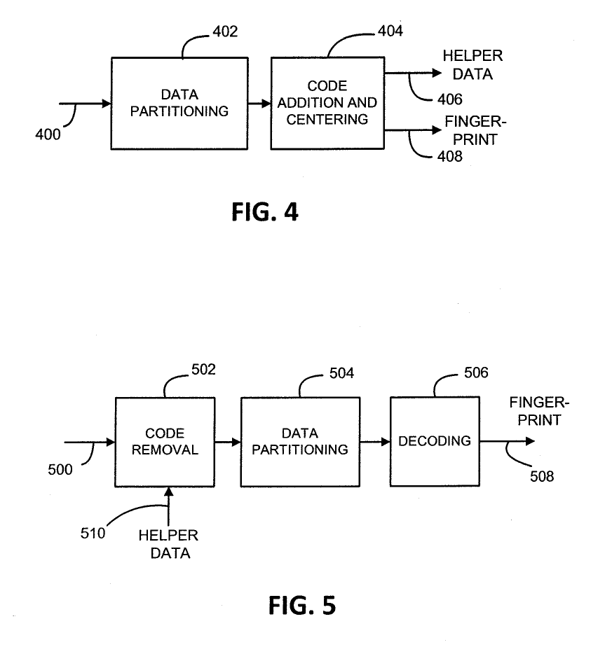

Referring now to FIG. 4, threshold generation 108 can include, but is not limited to including, data partitioning process 402 configured to group readings obtained from multiple locations 400 together to form a data block, and code addition and centering process 404 configured to add a code word to each symbol in the data block yielding helper data 408 and fingerprint 406 of physical source. Fingerprint 406 may be further processed with privacy amplification techniques for use in security applications.

Referring now primarily to FIG. 4, threshold generation process 108 (FIG. 1) can include, but is not limited to including, the step of partitioning the list v into two lists g and h where the element gᵢ is assigned with the value of the most significant s bits of vᵢ and hᵢ is assigned with the value of the remaining least significant l−s bits of vᵢ for i=0, 1, . . . , n−1. If s=2, then the lists g and h contain n=500 s=2 bit and l−s=3 bit integer values, respectively. Code addition and centering process 404 can include, but is not limited to including, the step of picking a codeword c=c₁, c₂, . . . , cₙ₋₁ where cᵢ represents symbols of the code. Fingerprint 408 is the list c. Code addition and centering process 404 can further include the step of obtaining a new list q by concatenating each element of the list q in their least significant l−s bits with the constant string “100 . . . 0”, i.e. a “1” bit followed by l−s−1 zero bits. The codeword c can be chosen from a code of length n=500 with symbols of size s=2 bits, and each symbol can be concatenated with the fixed string “100” in the least significant bits to the l=5 bit elements of the list q. Finally, the helper data 406 can be computed as wᵢ=vᵢ+qᵢ for i=0, 1, 2, . . . , n−1

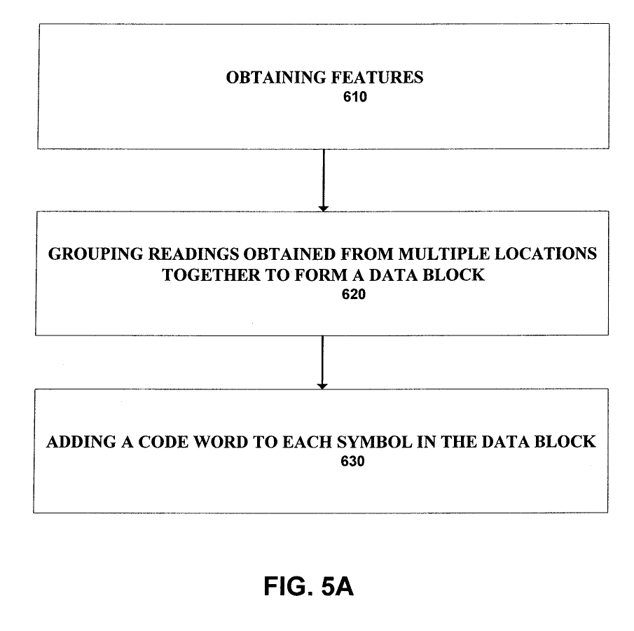

Referring now primarily to FIG. 5, threshold reproduction process 208 (FIG. 2) can include, but is not limited to including, data partitioning 504 configured to group readings obtained from multiple locations 500 together to form a data block, and code removal process 502 configured to process the data block, optionally with the aid of the helper data 508 yielding fingerprint 506. Before further use fingerprint 506 may be further processed using privacy amplification techniques especially for use in security applications. Threshold reproduction process 208 (FIG. 2) can recreate fingerprint 210 (FIG. 2) possibly with the aid of the helper data 212 (FIG. 2), and can include, but is not limited to including, the steps of subtracting the input list v′ 500 (FIG. 5) from helper data 510 (FIG. 5) fₜ=wₜ v′ₜ for i−0, 1, 2, . . . , n−1, and forming a new ordered list c′ from the most significant s bits of each element. Note that the list c′ is the noisy version of the codeword c chosen during fingerprint generation process 401 (FIG. 4). Threshold reproduction process 208 (FIG. 2) can also include the step of decoding the noisy codeword c′ to fingerprint 508 c as long as the noise is within the decoding capability of the code.

Decoding 508, as used in FIG. 5, refers to decoding of error correcting codes. Such a decoding is performed utilizing conventional methods. In some embodiments, the data partitioning 504 and the code removal 502 can be interchanged.

Referring again to FIG. 5, to reproduce the fingerprint of the CD the same steps of fingerprint generation are followed, except threshold reproduction process 208 (FIG. 2) replaces threshold generation process 108 (FIG. 1). Threshold reproduction process 208 (FIG. 2) can include, but is not limited to including, the step of subtracting input list v′ 500 (FIG. 5) from helper data 510 (FIG. 5) fᵢ=wᵢ−v′ᵢ for i=0, 1, 2, . . . , n−1. Data partitioning process 504 (FIG. 5) can include, but is not limited to including, the step of forming a new ordered list c′ from the most significant s bits of each element, and decoding the noisy codeword C′ to fingerprint 508 c (FIG. 5).

In the embodiments disclosed hereinabove, the fingerprint is generated directly from the optical medium. In embodiments in which more than one measurable feature can be identified or detected, the method described hereinabove can be applied repeatedly to the generation of multiple fingerprints.

The method of the present teachings, although illustrated herein for the exemplary embodiment of optical discs, can be applied to any object with measurable features. Referring now primarily to FIG. 5A, the method of the present embodiment for generating a fingerprint can include, but is not limited to including, the steps of obtaining features (feature measurements), grouping readings obtained from multiple locations 400 together to form a data block, adding a code word to each symbol in the data block yielding helper data 406 (FIG. 4) and fingerprint 408 (FIG. 4) of physical source 100 (FIG. 1). The step of obtaining the features can include, in one embodiment, the steps of acquiring data from the object, extracting features from the acquired data, and deriving measurable properties (also referred to as measures) from the features. Fingerprint 406 (FIG. 4) may be further processed with privacy amplification techniques for use in security applications. The method of the present embodiment for threshold generation can include, but is not limited to including, the steps of inputting data 400 (FIG. 4) as a list v₀, v₁, . . . , vₙ₋₁ of integer values with fixed l bits precision, dividing the list v is divided into two lists g and h, assigning the element gᵢ with the value of the most significant s bits of vᵢ, assigning hᵢ with the value of the remaining least significant l−s bits of vᵢ for i=0, 1, . . . , n−1, and computing helper data 406 (FIG. 4) and fingerprint 408 (FIG. 4). The step of computing helper data 406 (FIG. 4) can include, but is not limited to including, the steps of selecting a codeword c from a block code with block size n and symbols of size s, and representing the codeword c as an ordered list of n symbols of s bit precision, i.e. c=c₀, c₁, c₂, . . . , cₙ₋₁. Fingerprint 408 (FIG. 4) can be the list c, or the hash of the list v₀, v₁, . . . , vₙ₋₁, where the hash can be used to amplify the privacy of the list v₀, v₁, . . . , vₙ₋₁. The step can further include the steps of obtaining a new list q by concatenating each element of the list c in their least significant l−s bits with the constant string “100 . . . 0”, i.e. a “1” bit followed by l−s−1 zero bits, and computing helper data 406 as wᵢ=vᵢ+qᵢ for i=0, 1, 2, . . . , n−1.

Referring again primarily to FIG. 5A, method 500 can be, in whole or in part, implemented electronically. Control and data information can be electronically executed and stored on computer-readable medium. Method 500 can be implemented to execute on a node in internet. Common forms of computer-readable media can include, but are not limited to including, for example, a floppy disk, a flexible disk, a hard disk, magnetic tape, or any other magnetic medium, a CDROM or any other optical medium, punched cards, paper tape, or any other physical or paper medium, a RAM, a PROM, and EPROM, a FLASH-EPROM, or any other memory chip or cartridge, or any other medium from which a computer can read. As stated in the USPTO 2005 Interim Guidelines for Examination of Patent Applications for Patent Subject Matter Eligibility, 1300 Off Gaz. Pat. Office 142 (Nov. 22, 2005), on the other hand, from a technological standpoint, a signal encoded with functional descriptive material is similar to a computer-readable memory encoded with functional descriptive material, in that they both create a functional interrelationship with a computer. In other words, a computer is able to execute the encoded functions, regardless of whether the format is a disk or a signal.

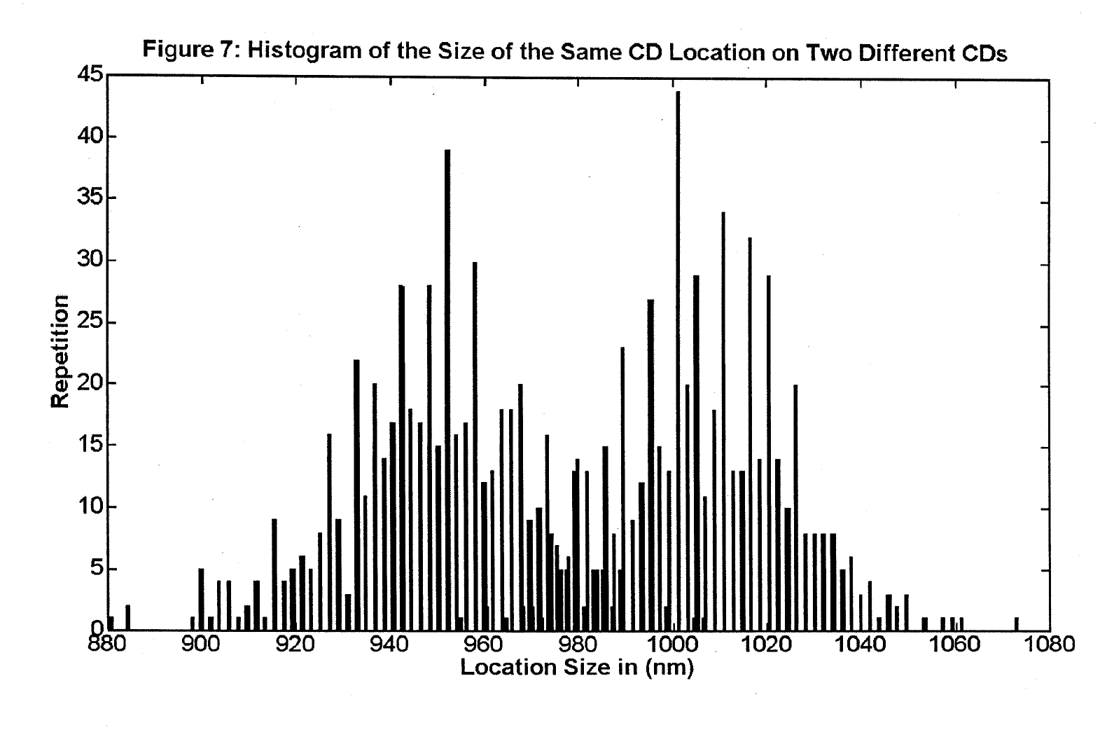

Referring now to FIG. 7, one feature from two identical CDs with q on the order of 550. The figure shows a difference in the feature size even when the CDs are intended to be identical. FIG. 7 shows the length of one location on each of the two CDs. As can be seen from the figure, although the two CDs are identical the feature size of the same location on both CDs is different.

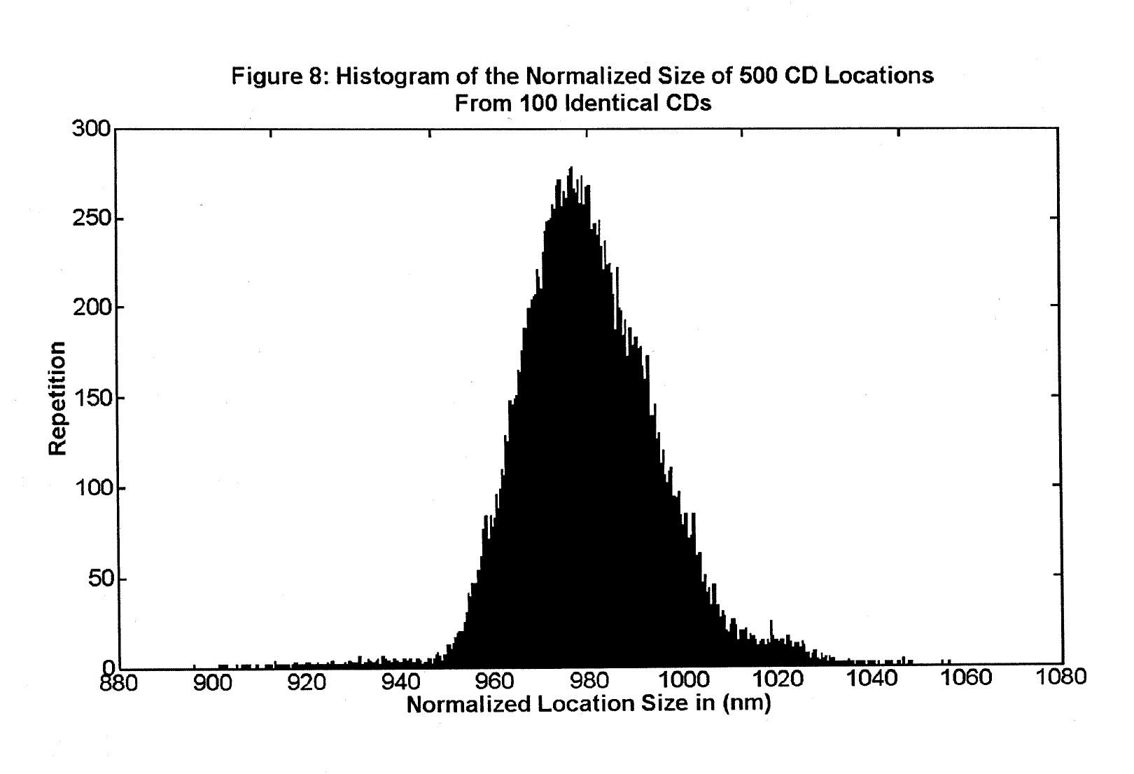

Referring now to FIG. 8, from a test including 100 CDs over n=500 pits, lengths extracted from multiple readings from the same pit or land follow a near Gaussian distribution with standard deviation of about 20 nanometers. The distribution of the pit lengths extracted from the same pit on 100 CDs pressed with identical data was also found to follow a Gaussian distribution with standard deviation of about 21 nanometers, as shown in FIG. 8.

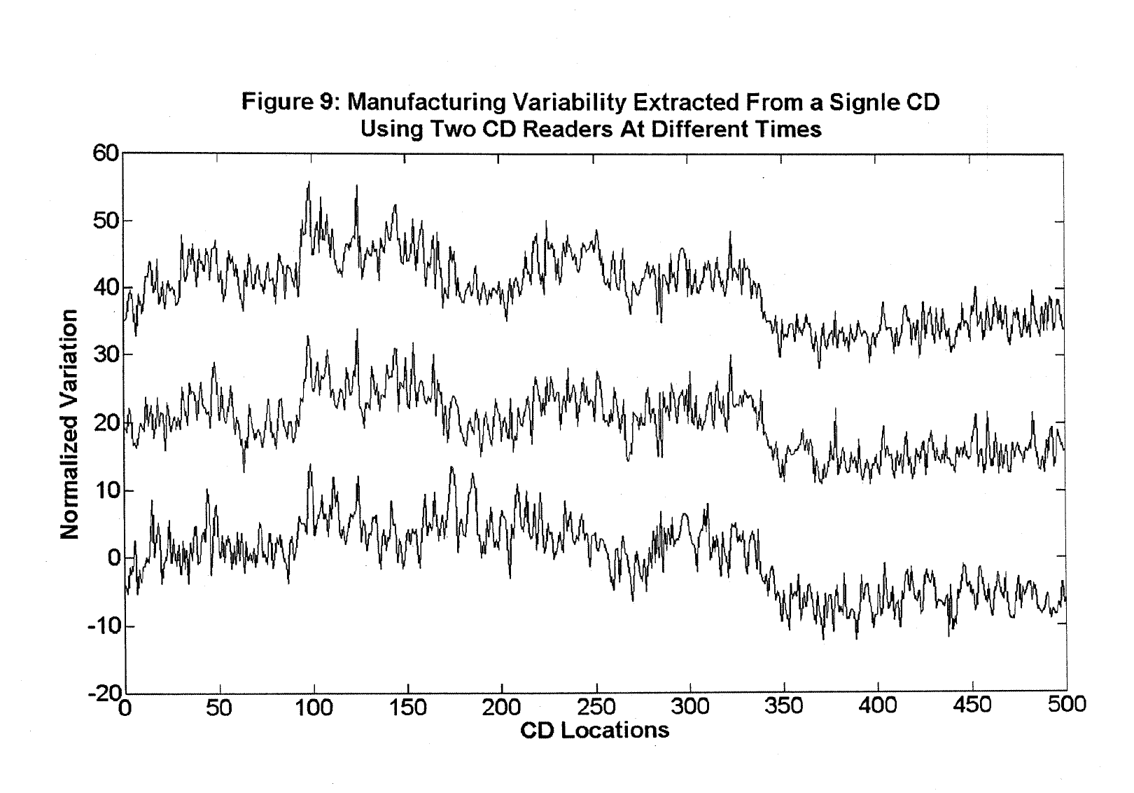

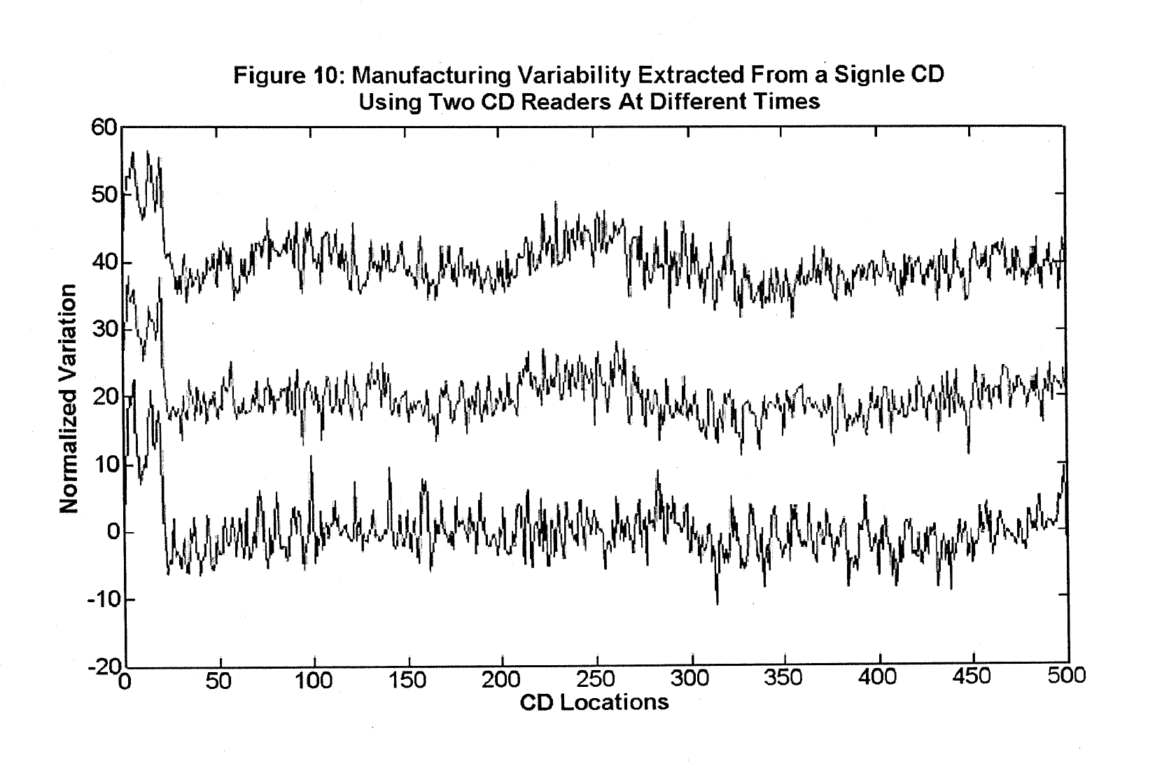

Referring to FIGS. 9 and 10, after the adjustment the list now fits into l=ceil (log₂ (max(v))). v is extracted from two identical CDs using different readers and different times. FIGS. 9 and 10 show a difference in the fingerprint although the two CDs are identical. Moreover, even when different readers are used at different times the fingerprint extracted from the same CD will be consistent. In these experiments, l−s. Therefore, after shifting by the minimum value, the elements of v fit into the range [0, 2⁵−1]. The graph contains three traces with a horizontal offset artificially introduced on two of the three traces in order to show the similarities in the three traces. The lower two traces are obtained from one reader at two different times. The top trace is obtained using a different reader three months after the first two traces were obtained.

When a fingerprint is derived from each CD it becomes possible to provide copy protection mechanisms or access control mechanisms for the CD. In a simple license scheme the license key can be delivered in printed form, for example on the CD or its case. Typical off-line license distribution schemes can be summarized as follows: identical copies of installation software can be pressed on multiple CDs. A unique license key can be printed on the cover of each CD. The CDs can be sold to customers. Customers can execute the installation software on their machines. During installation each customer can enter the license key to the installer. The installer can check the validity of the license. If valid, the installer can copy the software to the target machine.

Another embodiment is described as follows. The license key can be the helper data w along with the encrypted version of the fingerprint MAC_{K}(x) where MAC_{K}(□) is a message authentication code. A secret key K can be known to the installer and x can be the unique fingerprint extracted from the CD. In this protocol the CD reader can provide the fingerprint x. The installer can be fed with (w, MAC_{K}(x)) which can be supplied with the CD. The installer can then reproduce the fingerprint x which can be derived with the help of the reader. The installer can then check whether MAC_{K}(x)=MAC_{K}(x′) is satisfied. If the condition is satisfied the installer can conclude that the CD is authentic and may allow access to its contents.

Yet another embodiment can be described as a software access control mechanism that uses an on-line service as follows. When a user is interested in buying software p online from software provider, the user can employ a CD reader/writer to write information to part of a CD, and can employ the information to extract a fingerprint x from the CD. The fingerprint can then be sent online to the software provider that generates y=MAC_{K}(x) where MAC_{K}(□) is a message authentication code and the secret key K is known to the installer. The software provider can then compute E_{y}(p) where E_{y}(□) is an encryption function which can employ y as a key. The software provider can send E_{y}(p) to the user who can write the received information to a separate part of the CD. To retrieve the information on the CD, the installer can obtain the fingerprint x and use the private key K to generate y. At this point the installer can use y to decrypt the program p and run it.

The present embodiment can create a standalone CD in which the information stored on the CD is encoded in a way that is dependent upon the physical structure of CD. In the present embodiment, multiple write operations can be employed to provide copy protection and access control.

In another embodiment of the invention, secret locations on the CD can be used to extract the fingerprint. As an example, the owner can keep these locations secret and only discloses them to the reader when there is a need to check the authenticity of the CD.

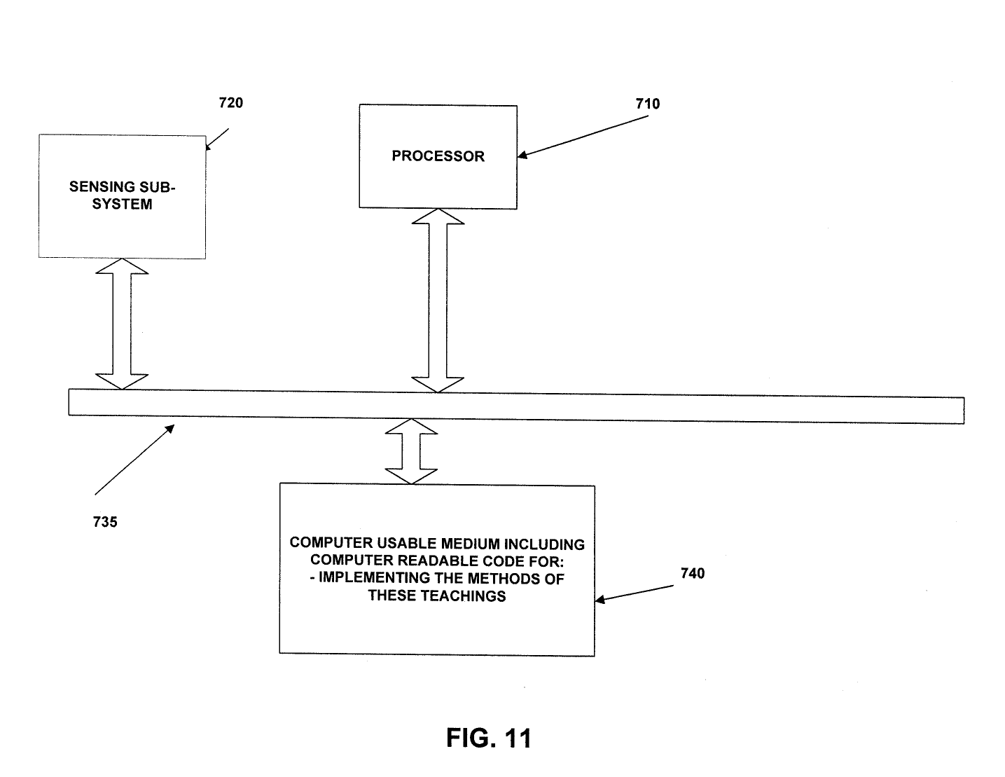

In one instance, shown in FIG. 11, the system of these teachings includes one or more processors 710, a detector or sensing sub-system 720, and one or more computer usable media 740 having computer readable code embodied therein, the computer readable code causing the one or more processors 710 to perform the methods described herein above. The components of the system are operatively connected by an interconnection component 635 such as a computer bus.

Although the teachings have been described with respect to various embodiments, it should be realized these teachings are also capable of a wide variety of further and other embodiments.

What is claimed is:

1. A method for fingerprinting an object comprising the steps of:
obtaining, using a sensing system, measures for features on the object; the measures constituting properties;
grouping properties obtained from multiple locations on the optical disc to form a data block; and
generating a fingerprint by adding a codeword to each symbol in the data block

2. The method as in claim 1 wherein the step of obtaining measures for features on the object comprises the steps of
acquiring data from the object;
extracting features of the object from the acquired data; and
deriving properties from the features.

3. The method of claim 2 wherein the object is an optical recording medium.

4. The method as in claim 3 wherein the step of extracting features comprises the step of extracting features directly from the optical recording medium.

5. The method as in claim 3 wherein said step of generating a fingerprint comprises the step of:
generating the fingerprint directly from the optical recording medium.

6. The method as in claim 3 wherein said step of generating a fingerprint comprises the step of:
generating multiple fingerprints from the optical recording medium.

7. The method as in claim 1 wherein said step of generating a fingerprint comprises the step of:
generating the fingerprint using an electrical signal from a detector.

8. The method as in claim 3 wherein said step of generating a fingerprint comprises the step of:
generating the fingerprint using a laser reflected from the optical recording medium's surface.

9. The method as in claim 3 wherein said step of generating a fingerprint comprises the step of:
generating the fingerprint using images of the optical recording medium's surface.

10. The method as in claim 3 wherein the feature of the optical recording medium is related to the geometry of the stored data.

11. The method as in claim 3 wherein the property of the optical recording medium is related to the geometry of the optical recording medium surface.

12. The method as in claim 1 wherein said step of grouping properties comprises the steps of
eliminating noise;
normalizing the properties;
adjusting a range for the properties; and
quantizing the properties.

13. The method as in claim 3 further comprising the step of:
extracting the fingerprint from secret addresses on the optical recording medium.

14. The method as in claim 1 further comprising the step of
processing the fingerprint with privacy amplification techniques to generate an integrity-check for the fingerprint.

15. The method of claim 14 wherein the object is an optical recording medium.

16. The method as in claim 14 further comprising the step of:
authenticating the fingerprinted optical recording medium using the integrity-check.

17. The method as in claim 3 further comprising the step of:
encrypting the data on the optical recording medium using the fingerprint.

18. A method for copy protecting optical recording media comprising the steps of:
generating a fingerprint;
computing an integrity-check of the fingerprint; and
controlling access to optical recording medium content if the fingerprint matches the fingerprint integrity-check.

19. The method of claim 18 further comprising the step of:
computing the integrity-check based on a message authentication code and a key encryption function.

20. The method of claim 18 further comprising the step of:
encrypting the optical recording medium content.

21. A method for tying information to an optical recording medium comprising the steps of:
generating a fingerprint;
computing an integrity-check;
writing information on the optical recording medium; and
controlling access to the information on the optical recording medium.

22. The method of claim 21 further comprising the step of:
writing the information to multiple parts of the optical recording medium.

23. The method of claim 21 further comprising the step of:
encrypting the information before the information is written to the optical recording medium.

24. The method of claim 21 further comprising the step of:
computing the integrity-check online.

25. The method as claimed in 21 further comprising the step of:
encrypting the information using the integrity-check.

26. The method of claim 21 further comprising the step of:
computing the integrity-check based on a message authentication code and a key encryption function.

27. A method for authenticating physical objects comprising:
attaching an optical tag to a physical object;
generating a fingerprint and an integrity-check; and
authenticating the optical tag using the integrity-check.

28. A system for generating a fingerprint for an object, the system comprising:
a detector; the detector acquiring data from the object;
a processor; and
a computer usable medium having computer readable code embodied therein; said computer readable code causing the processor to:
obtain, using the detector, measures for features on the object; the measures constituting properties;
group properties obtained from multiple locations on the optical disc to form a data block; and
generate a fingerprint by adding a codeword to each symbol in the data block.

29. The system of claim 30 wherein said computer readable code in causing the processor to obtain, using the detector, measures for features on the object, causes the processor to:
acquire data from the object;
extract features of the object from the acquired data; and
derive properties from the features.

30. A computer-readable medium having instructions for carrying out the method according to claim 1.

31. A communications network having a node for executing instructions to carry out the method of claim 1.

32. A node within a communications network for executing instructions to carry out the method of claim 1.
